(19) United States
(12) Patent Application Publication
(10) Pub. No.: US 2023/0371738 A1
(43) Pub. Date: Nov. 23, 2023

(54) Refrigerated or Heated Food Ingredient Dispenser for Automated Cooking Apparatus

(71) Applicant: Kitchen Robotics Ltd., Modiin (IL)

(72) Inventors: Yair GORDIN, Ramat Gan (IL); David BEN-DAVID, Rehovot (IL); Zev MILLER, Modiin (IL)

(21) Appl. No.: 17/663,895

(22) Filed: May 18, 2022

(51) Int. Cl. A47J 36/32; B65G 33/12; B65G 47/18

(52) U.S. Cl. CPC A47J 36/32; B65G 33/12; B65G 47/18

(57) ABSTRACT

The present invention provides an array of refrigerated or heated food ingredient dispenser provided with an air-conditioning tunnel (ACT) which warps the surface of the DiU, wherein each ACT may have an input-opening and an output-opening. The ingredient dispenser comprising at least one dispensing unit capable of handling a single type of ingredient. Each of the dispensing unit may comprise a food ingredient box (FIB) and a conveying mechanism (CoM) with a conveying-screw unit (CoS). The FIB is provided with a cartridge and two covers, a top cover & bottom cover.

### FIELD OF THE DISCLOSURE

The present disclosure relates to dispensing of hot or cold food ingredients through an automated cooking machine (ACM). And more particularly it relates to using a plurality of food dispensers in an air-conditioned environment, stacked in an array, wherein the components of the food ingredient dispensers are removable and replaceable without hindering or stalling the automated cooking operation.

### BACKGROUND

In order to deliver high quality repeating meals, each dish of the same course has to contain the same food ingredients. Each ingredient has to be in appropriate quantity, temperature, humidity, etc. Usually the required quantity of one ingredient in a recipe/dish differs from the required quantity of another ingredient in the same or different recipe/dish. Since an ACM (Automated Cooking Machine) is configured to deliver a plurality of courses, some of the food ingredients are used more than the other. Hence, refilling of a food-ingredient-box (FIB) is not synchronized with refilling of another FIB. Consequently a common dispenser can be frequently transferred to a standby position for refilling an empty FIB.

Some of the food ingredients are solid, such as but not limited to meat, fish, vegetables, peanuts, etc. Other food ingredients are powder such as but not limited to flour, sugar, salt, etc. Other food ingredients can be fluid such as but not limited to oil, soya, etc. Further, some of the ingredients might be fresh; some might be half cooked or fully cooked. Other ingredients might be sliced such as but not limited to pasta, tomatoes, olives, etc.

Further, during handling, some food ingredients in a common dispenser, may generate fluid. Handling fruits or vegetables may generate juice. Handling fresh meat may generate blood. Such fluid may be delivered with the food ingredient and may affect the total amount of its associated ingredient, which may reduce the quality of the cooked course.

Consequently, dispensing of food ingredients is a key factor in automated food preparation processes. Performance and efficiency of food preparation automated systems is highly dependent on factors such as food ingredient dispensing speed, accuracy, ingredient refill duration, cleaning and maintenance duration. Apart from these, the dispensed food ingredients must comply with the food safety regulations, basic of which require these to be kept refrigerated or heated, as the case (nature of the ingredient) may be.

U.S. Ser. No. 10/617,253 titled, “System and method for an automatic cooking device” is about a system and method for an automated cooking device that includes a multi-ingredient dispenser with a base, liquid dispenser and a dispensing selector, wherein the base comprises a set of base receptacles; a set of ingredient dispenser units that removably couple with the base receptacles and controllably open when in an engaged mode with the dispensing selector of the multi-ingredient dispenser; a cooking apparatus with a heating unit and mixing unit; and a control unit that is configured to process a multi-stage cooking process and that at least partially controls the dispensing selector, heating unit, mixing unit, and liquid dispenser.

While the ACMs discussed in the above inventions, all utilizes dispensers in adding specific ingredients associated with a typical menu by means of an automated cooking process, no mention of the status of these ingredients during dispensing is being mentioned.

The needs and the deficiencies that are described above are not intended to limit the scope of the inventive concepts of the present disclosure in any manner. The needs are presented for illustration only. The disclosure is directed to a novel apparatus and method for dispensing refrigerated or heated food ingredient with the aim of enhancing the shelf-life of the ingredients as well as fulfilling the objective of using fresh ingredients during cooking.

### BRIEF SUMMARY OF THE INVENTION

An aspect of the invention is to provide a temperature conditioned, (refrigerated or heated) food ingredient dispenser aligned with an automated cooking apparatus.

A still further aspect of the invention is to provide a food ingredient dispenser which can dispense food ingredients in required quantities and at required temperature, humidity and other conditions.

A still further aspect of the invention is to provide a food ingredient dispenser which is configured to handle a plurality of types of food ingredients such as but not limited to meat, vegetables, rice, pasta, peanuts, etc., which differ from each other and may require different handling.

Another aspect of the invention is to provide a dispenser which might be suitable for dispensing solid food such as meat, fish, vegetables, peanuts.

A further aspect of the invention is to provide a food ingredient dispenser which might be suitable for dispensing powdered food ingredient such as flour, sugar, salt, etc.

A still further aspect of the invention is to provide a food ingredient dispenser which might be suitable for dispensing food ingredients which might be fresh; some might be half cooked or fully cooked whereas, other ingredients might be sliced such as but not limited to pasta, tomatoes, olives, etc.

Another aspect of the invention is to provide a food ingredient dispenser which refills the food ingredient boxes in a synchronized manner to avoid any delay in ingredients delivery for the recipe.

An aspect of the invention is to provide a refrigerated or heated food ingredient dispenser comprising at least one dispensing unit capable of handling a single type of ingredient. The dispensing unit may comprise a food ingredient box (FIB) and a conveying mechanism (CoM) with a conveying-screw unit (CoS). The FIB is provided with a cartridge and two covers, a top cover & bottom cover.

Another aspect of the invention is to provide a food ingredient dispenser which drains any excess liquid generated during handling of the food ingredients such as but not limited to juice from fruits, blood from fresh meat etc.

A further aspect of the invention is providing a plurality of dispensing units, stacked in an array, containing food ingredients requiring a specific temperature such as either refrigeration or heating.

Yet another aspect of the invention is removing or replacing one or more dispensing units during continuous operation of an automated cooking machine and the temperature conditioning system.

Another aspect of the invention is, provision of washing and cleaning of the components of the dispenser by removing it for either manual wash or washing in a residential or commercial dishwasher.

A still further aspect of the invention is providing the dispensing units of the present invention, with an air-conditioning tunnel (ACT) which warps the surface of the DiU, wherein each ACT may have an input-opening and an output-opening. The ACT is arranged such that when two or more DiUs are assembled in an array the output-opening of the ACT of a first DiU is adjacent to the input-opening of the following DiU, thus generating a continuing ACT.

These and other aspects of the disclosure will be apparent in view of the attached figures and detailed description. The foregoing summary is not intended to summarize each potential embodiment or every aspect of the present invention, and other features and advantages of the present invention will become apparent upon reading the following detailed description of the embodiments with the accompanying drawings and appended claims.

Further, although specific embodiments are described in detail to illustrate the inventive concepts to a person skilled in the art, such embodiments can be modified to various modifications and alternative forms. Accordingly, the figures and written description are not intended to limit the scope of the inventive concepts in any manner.

Other objects, features, and advantages of the present invention will become apparent upon reading the following detailed description of the embodiments with the accompanying drawings and appended claims.

### BRIEF DESCRIPTION OF THE DRAWINGS

Some examples of embodiments of the present disclosure will be understood and appreciated more fully from the following detailed description, taken in conjunction with the drawings in which:

FIG. 1 schematically illustrates an example of a food-ingredient-box (FIB);

FIG. 2 schematically illustrates relevant elements of a dispensing-unit (DiU);

FIG. 3 illustrates a side view of a DiU indicating the slope; and

FIG. 4 schematically illustrates a cross-sectional view of a dispenser having an air conditioned array of DiUs.

### DETAILED DESCRIPTION OF SOME EXAMPLE EMBODIMENTS

Turning now to the figures in which like numerals represent like elements throughout the several views, in which exemplary embodiments of the disclosed techniques are described. For convenience, only some elements of the same group may be labeled with numerals.

The purpose of the drawings is to describe examples of embodiments and not for production purpose. Therefore, features shown in the figures are chosen for convenience and clarity of presentation only. In addition the figures are drawn out of scale. Moreover, the language used in this disclosure has been principally selected for readability and instructional purposes, and may not have been selected to define or limit the inventive subject matter, resort to the claims being necessary to determine such inventive subject matter.

In this specification, these implementations, or any other form that the invention may take, may be referred to as techniques. In general, the order of the steps of disclosed processes may be altered within the scope of the invention. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

In the following description, the words “unit,” “element,” “module”, and “logical module” may be used interchangeably. Anything designated as a unit or module may be a stand-alone unit or a specialized or integrated module. A unit or a module may be modular or have modular aspects allowing it to be easily removed and replaced with another similar unit or module. In addition the terms element and section can be used interchangeably.

In the following description and claims, the terms ingredient-collecting-vessel can be a pot, a cooking device, a serving plate, a vessel etc. Along the present disclosure and the claims the term pot may be used as a representative term for this group.

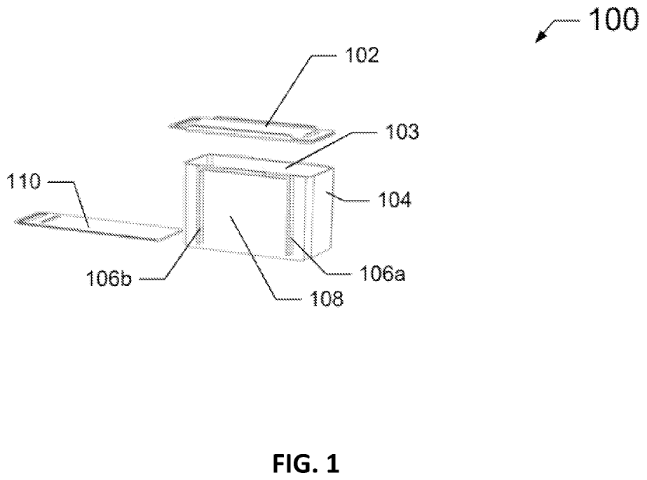

FIG. 1 schematically illustrates relevant elements of an example of a food-ingredient-box (FIB) 100. An example of FIB 100 may comprise a container 104 and two covers, a top cover 102 and a bottom cover 110. Both sides of the container 104 may be associated with air-conditioning tunnel (ACT) 108 located between two ACT walls 106a and 106b. The top of the container 104 and the bottom of container 104 can have slots (not shown in the figures) through which the top cover 102 and the bottom cover 110 can be pushed.

The height of an example FIB 100 may be in the range of 15 to 40 centimeters, 20 centimeters for example. The width of an example FIB 100 may be in the range of 5 to 15 centimeters, 10 centimeters for example. The length of an example FIB 100 may be in the range of 15 to 40 centimeters, 20 centimeters for example.

Some example of FIB 100 may be made of polycarbonate, such as but not limited to Makrolon, which is a food grade polycarbonate. Additional possible materials may be stainless steel, aluminum, such as cast aluminum, thermoplastic polyurethane, food grade plastics, etc.

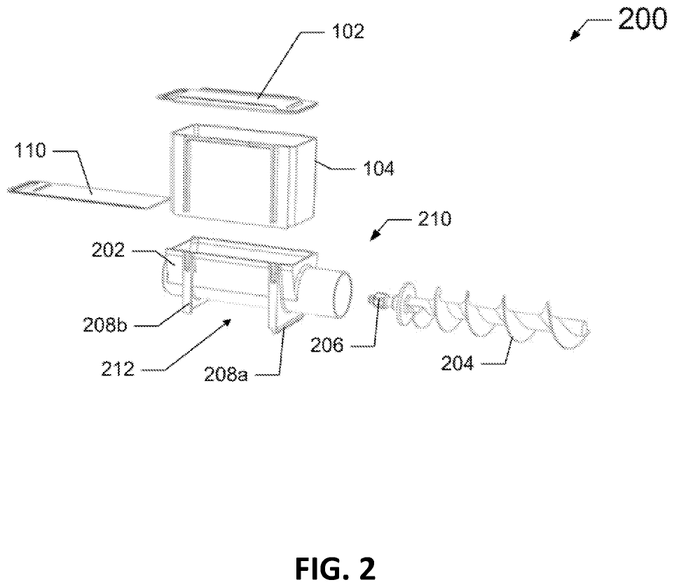

FIG. 2 schematically illustrates relevant elements of a dispensing-unit (DiU) 200. DiU 200 may comprise of an FIB 104 with the two covers 102 and 110 and a CoM unit 210. The FIB 104 has been disclosed above in detail. CoM unit 210 may comprise a body 202 of the CoM unit 210, two pillars, a first pillar 208a and a second pillar 208b, and a CoS 204 with its quick disconnecting mechanism 206. The first pillar 208a is higher than second pillar 208b thus generating a slope of few degrees between the two ends of the CoM unit 210. The slope may be in the range of 0.1 to 5 degrees. In some example embodiments the slope may be 3 degrees.

The slope allows the fluid to be generated while the food ingredient is in the DiU 200, to flow along the slope and be drained via one or more holes in the CoS unit 210 towards a ditch that leads the fluid away from the dispenser. In an example embodiment of CoS unit 210 the holes may be located between pillar 208b and the wall at the opposite side to the opening of the DiU 200. The slope forces the liquids to drain in a direction opposite to the ingredient exit, by gravitational force, which is collected in a dedicated tray or any other collecting means.

Once the, bottom cover 110 of the FIB, is slid open, the ingredient from the cartridge is delivered to the CoS unit and is conveyed toward an opening of the CoS unit. The opening of the CoS unit is the opening of the DiU from where the relevant ingredient is delivered to an ingredient-collecting-vessel.

The dispenser unit (DiU) 200 is configured to handle a plurality of food ingredients. Food ingredients such as but not limited to meat, vegetables, rice, pasta, peanuts, etc. are usually dispensed in requisite proportions, typical to a pre-assigned menu to be cooked. Those ingredients differ from each other and may require different handling. Therefore, the disclosed dispenser is configured to be associated with a plurality of types of CoS. Depending upon the type of the food ingredient that will be associated with a certain DiU the operator of the ACM can select a CoS unit that match that food ingredient. Thus, the structure of the CoS and the interface enables using different types of CoS, with variations in terms of pitch, geometry, material, and thereby supporting plurality of ingredients. For example for powder like solid ingredients, such as sugar, salt or rice, a rigid CoS may be used, made from materials including stainless steel, food grade plastics, food grade polyurethane.

However, for bulky and rigid ingredients such as apples, chicken, beef, the CoS will be made from soft material such as TPU (thermoplastic polyurethane). For rigid food ingredients such as but not limited to beet, apple, potato, etc. the CoS 204 may be made of rigid material such as but not limited to metal and may have sharp edges in order to cut pieces of the food ingredients. Thus the CoS 204 can sweep the food ingredients toward the opening of the DiU 200.

All components of the dispenser of the present invention may be removed for washing, which may be manual wash or by means of residential or commercial dishwasher. Further, since the components are co-replaceable, a continuous operation of the ACM may be ensured, even when a certain component is removed for washing, and is replaced by a clean one. This due to the fact that the size and geometry of each one of the dispenser components enables using a residential dishwasher to wash plurality of the dispensers.

The FiB of the present invention, being an independent module, a certain ingredient might be dispensed using a different auger type, thus altering the dispense parameters. For example, olives may be dispensed with a coarse auger, resulting in relatively large dispensed quantities per revolution and on the other hand using finer pitch auger, results in dispensing of smaller quantities per auger revolution.

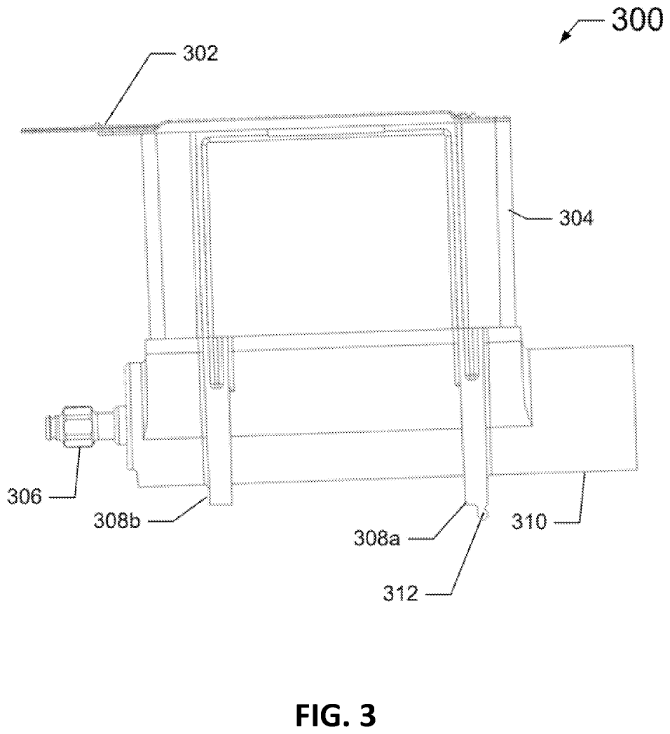

FIG. 3 illustrates a side view of an assembled DiU 300, wherein the FIB 304 with the top cover 302 are placed above the CoS unit 310. Further, the figure indicates the slope of the CoS unit 310. As is illustrated, the pillar 308a is longer than pillar 308b. Thus, when the DiU 300 is placed on a flat surface of a dispenser a slope of few degrees between the two ends of the CoS unit 310 is generated. The slope may be in the range between 0.1 and 5 degrees. Bulb 312 may be used for holding the DiU 300 in the dispenser during operation. Quick disconnecting mechanism 306 is ready to be associated with an electrical motor or a pneumatic motor. The motor is configured to turn the CoS in order to move the relevant ingredient towards the opening of the DiU.

The quick disconnecting/releasing mechanism enables the auger or the CoS to be constrained, which results in manually or automatically engaging, or disengaging, thereby locking and unlocking the dispenser auger. Manually operated release mechanism, for example, as described, transfers the rotational movement from the electrical motor to the auger, thus rotating it and comprises of a retainer socket, which can be manually engaged and disengaged locking and unlocking the auger and the dispenser in place. The engage and disengage is a result of a linear motion of the retainer socket which might be spring loaded, for default engage position. The interface between the retainer socket and the auger might be of hex cross section, or rectangular cross section or triangular cross section, in order to transmit the rotational force from the electrical motor, for example, to the auge. The rotational motion may be transmitted by incorporating elements such as keyway, pin or any other protruding element fitting into the retainer socket accordingly.

In some example embodiments of the disclosed technique, after delivering the desired amount of the ingredient, the motor may be configured to turn to other direction in order to pull the ingredient inwards, thus avoiding spilling of the ingredient and minimizing the exposure of the ingredient to open air.

In an embodiment, the disclosed dispenser may be arranged in one or more arrays of dispensing-units (DiUs). Each DiU may handle a type of ingredient. Each array of DiUs may comprise two or more DiUs, which contain food ingredients having similar temperature requirements. One array may be associated with ingredients that require refrigeration, whereas, another array may be associated with ingredients that require heating, etc.

In embodiments of the present invention, the structure, geometry and mounting interface of the dispenser in the ACM enables quick replacement as well as quick removal of the of the FiB and the dispenser for maintenance. The removal and insertion of the FiB and other components of the dispenser does not require any tools and may be performed without stopping or disturbing the regular workflow of the ACM, thereby, saving time and enabling fluent operation of the ACM.

In embodiments of the present invention, the design and structure of the FiB enables storing a food ingredient outside the ACM, for example in a refrigerator, within the FiB, thus having it ready for insertion to the ACM and quick replacement with a depleted one, during continuous operation.

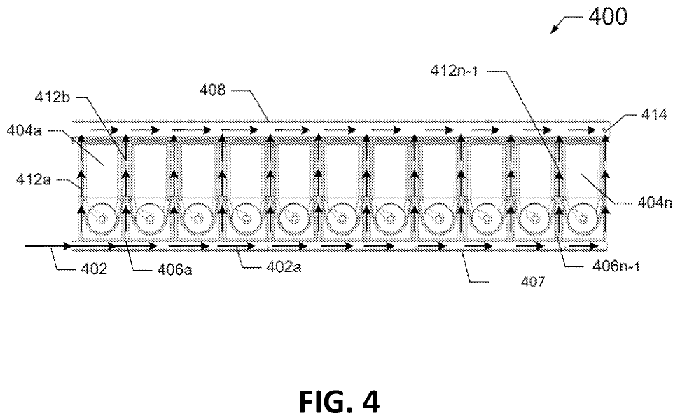

In an embodiment of the present invention, the dispensing units of the present invention are equipped with an air-conditioning tunnel (ACT) which warps the surface of the DiU, wherein each ACT may have an input-opening and an output-opening. The ACT is arranged such that when two or more DiUs are assembled in an array the output-opening of the ACT of a first DiU is adjacent to the input-opening of the following DiU, thus generating a continuing ACT. This is explained in detail in FIG. 4

FIG. 4 schematically illustrates a cross-sectional view of a dispenser 400 having an air conditioned array of ‘n’ DiUs (404a to 404n), wherein ‘n’ is integer number of two or more DiUs 404. Air-conditioning stream of air 402 is forced into a bottom ACT, which was generated between the two pillars 308a and 308b (FIG. 3) of each DiU 404a-n and a bottom 407 of the dispenser. At each junction (406a to 406n-1) part of the air-conditioning stream 412a to 412n is moved up via ACT 108 that is located between the two ACT walls 106a and 106b (FIG. 1) of each DiU 404a-n. Top cover 408 force the moving up streams 412a to 412n to turn toward the exit 414. The air flow regime is determined by the pressure difference between the air inlet at the bottom of the ACT and outlet or the exit of the top ACT. An air blower or fan, generating the conditioned air flow, introduces a high pressure at the inlet and low pressure at the outlet or the exit. The conditioned air flows from the high to low pressure, passing the channels defined by the geometry of the DiU array.

Working of the Food Ingredient Dispenser in Sync with ACM

During preparation stage two or more FIB 100 may be loaded with food ingredients and be kept in appropriate temperatures waiting for replacing an empty FIB 100. Replacing the empty FIB 100 may be done while the ACM is operating. An operator of the ACM may push the bottom cover 110 and the top cover 104 to the relevant slots of the empty FIB. Then the empty FIB 100 may be removed and the loaded FIB 100 can be placed instead of the removed empty FIB 100. After placing the loaded FIB the bottom cover 110 and the top cover 104 of the loaded FIB 100 can be removed enabling the operation of the dispenser. Replacing an empty FIB may take few seconds, five to ten seconds for example. The empty FIB 100 can be transferred for washing thereafter.

The CoS 204 is configured to be pushed inside the CoS unit 210 up to the point in which the quick disconnecting mechanism 206 appears on the other side of the CoM unit 210. At this point the CoS 204 is placed below the bottom opening of FIB 104 ready to convey food ingredients from the FIB 104 toward an ingredient-collecting-vessel, such as but not limited to a pot (not shown in the figures).

In the description and claims of the present disclosure, each of the verbs, “comprise”, “include”, “have”, and conjugates thereof, are used to indicate that the object or objects of the verb are not necessarily a complete listing of members, components, elements, or parts of the subject or subjects of the verb.

The present disclosure has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Many other ramification and variations are possible within the teaching of the embodiments comprising different combinations of features noted in the described embodiments.

It will be appreciated by persons skilled in the art that the present invention is not limited by what has been particularly shown and described herein above. Rather the scope of the invention is defined by the claims that follow.

1. A food ingredient dispenser unit (DiU) for automated-cooking-apparatus comprising:
a food-ingredient-box (FIB); and
a conveying-mechanism (CoM) unit embedded with a CoM element and a quick disconnecting mechanism;
wherein, the FIB is configured to be associated with the CoM unit; and
wherein, the food ingredient from the FIB is delivered by the said CoM element, configured to deliver the food ingredient towards an ingredient-collecting-vessel.

2. The DiU of claim 1, wherein the CoM element is a conveying-screw (CoS).

3. The DiU of claim 1, wherein, the individual components of the DiU is removable, and co-replaceable during their washing, for maintaining a continuous operation of the Automated Cooking Machine (ACM).

4. The DiU of claim 3, wherein the washing is manual wash or by washing means.

5. The DiU of claim 3, wherein the washing means is residential or commercial dishwasher.

6. The DiU of claim 1, wherein the said CoM unit is further supported by two pillars, a first pillar and a second pillar, and further wherein, the first pillar is higher than the second pillar, thereby generating a slope between the two ends of the CoM unit.

7. The DiU of claim 6, wherein the slope generated between the two ends of the CoM unit, ranges between 0.1 and 5 degrees.

8. The DiU of claim 1, further comprising of four air-conditioning walls, one each on each side of the said DiU and the said two pillars, said first and second pillar, also configured to generate an air-conditioning tunnel (ACT) which warps the surface of the said DiU.

9. The DiU of claim 1, wherein the said FIB is configured to be replaced by another FIB while the automated-cooking-apparatus is operating.

10. The DiU of claim 1, wherein the said DiU is configured to be replaced by another DiU while the automated-cooking-apparatus is operating.

11. The DiU of claim 1, wherein the CoS is configured to be replaced by another CoS, depending upon the type of the food ingredients, while the automated-cooking-apparatus is operating.

12. The DiU of claim 2, wherein the CoS is adapted to the type of food ingredient that is carried in it's associated FIB.

13. The DiU of claim 12, wherein, when the food ingredient is from the group of powder including sugar, salt or flour, the CoS is rigid, made from any one of materials such as stainless steel, food grade plastics or food grade polyurethane.

14. The DiU of claim 12, wherein, the pitch, geometry and material of the CoS can be varied depending upon the nature of the ingredients.

15. A food ingredient dispenser for automated-cooking-apparatus comprising:
a top cover;
a bottom; and
an array of dispensing-units (DiUs);
wherein, the said array comprises at least 2 DiUs; and
wherein, an air-conditioning tunnel (ACT) is generated between the bottom of the dispenser and the top cover of the dispenser via spaces between the DiUs.

16. The food ingredient dispenser of claim 10, wherein the ACT is configured to wrap each one of the two or more DiUs.

17. A method of air conditioning an array of FIB/DiU, the method comprising:
Step 1: Generating a conditioned air flow by means of air blower or fan between the said first pillar and the second pillar of each DiU and the bottom of the dispenser;
Step 2: Developing a high pressure at the inlet of the ACT and a low pressure at the outlet of the ACT;
Step 3: Redirecting the generated air flow of step 1, at each juncture of any 2 DiUs to move up via ACT; and
Step 4: Directing the upward moving streams of air through the top cover of the DiU/FIB to move towards the outlet of the ACT.
